(19) United States
(12) Patent Application Publication
(10) Pub. No.: US 2014/0379912 A1
(43) Pub. Date: Dec. 25, 2014

(54) RADIUS SESSION LIMIT PER SERVICE TYPE

(71) Applicant: ALCATEL-LUCENT CANADA, INC., Ottawa (CA)

(72) Inventors: Tiru K. Sheth, Ottawa (CA); Ramaswamy Subramanian, Ottawa (CA)

(21) Appl. No.: 13/924,716

(22) Filed: Jun. 24, 2013

(51) Int. Cl. H04L 12/927

(52) U.S. Cl. CPC H04L 47/80
USPC 709/225

(57) ABSTRACT

Various exemplary embodiments relate to a method performed by a policy server in a communication network. The method includes: receiving an access request message including a vendor class identifier describing a device requesting network access; determining a service type based on the vendor class identifier; determining whether adding an additional session exceeds a limit for the service type; and performing a management action responsive to the additional session exceeding the limit for the service type.

### TECHNICAL FIELD

Various exemplary embodiments disclosed herein relate generally to communications networks.

### BACKGROUND

Communications network operators often provide various service types to a customer. For example, it is common for service providers to offer various combinations of voice, video, and high speed data service.

Service providers may provide customer equipment for accessing the various services. For example, service providers may provide set top boxes and residential gateways. Customers may also connect their own equipment such as phones, televisions, and computers to the service provider's network.

Customers may attempt to take advantage of service providers. For example, customers may share their high speed data service with neighbors or connect additional televisions to the service provider's network.

### SUMMARY

In view of the foregoing, it would be desirable to allow service providers additional control over their networks. In particular, it would be desirable to allow service providers to monitor the types of devices a subscriber connects to the network and make policy decisions based on the types of devices.

In light of the present need for service provider control, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a policy server in a communication network. The method includes: receiving an access request message including a vendor class identifier describing a device requesting network access; determining a service type based on the vendor class identifier; determining whether adding an additional session exceeds a limit for the service type; and performing a management action responsive to the additional session exceeding the limit for the service type.

In various embodiments, the management action comprises rejecting the additional session. The management action may further include sending a termination request to a service router.

In various embodiments, the management action includes charging an overage fee for the additional session.

In various embodiments, the vendor class identifier is a dynamic host configuration protocol (DHCP) option 60. The step of determining a service type based on the vendor class identifier may include comparing the vendor class identifier to predefined identifiers. The method may further include adding a vendor class identifier to the predefined identifiers.

In various embodiments, the service type is one of: a data session, a voice session, and a video session.

In various embodiments, the step of determining whether adding an additional session exceeds a limit for the service type includes: determining a current session count for the service type; determining a session limit for the service type; and determining whether the current session count is greater than or equal to the session limit.

In various embodiments, the method further includes configuring a subscriber profile with a session limit for a service type.

Various exemplary embodiments relate to a policy server in a communication network configured to perform the above identified method. The policy server may include a processor and a machine-readable storage medium configured to store a subscriber profile including a session limit for a service type.

Various exemplary embodiments relate to a non-transitory machine-readable storage medium encoded with instructions executable for a processor to perform the above described method.

It should be apparent that, in this manner, various exemplary embodiments enable network operator control of subscriber sessions. In particular, by establishing session type limits, a network operator may control the types of devices connected to a network.

### BRIEF DESCRIPTION OF THE DRAWINGS

In order to better understand various exemplary embodiments, reference is made to the accompanying drawings, wherein:

FIG. 1 illustrates an exemplary communications network;

FIG. 2 illustrates an exemplary policy server;

FIG. 3 illustrates an exemplary data arrangement for storing a subscriber profile; and

FIG. 4 illustrates a flowchart showing an exemplary method of making policy decisions.

### DETAILED DESCRIPTION

Referring now to the drawings, in which like numerals refer to like components or steps, there are disclosed broad aspects of various exemplary embodiments.

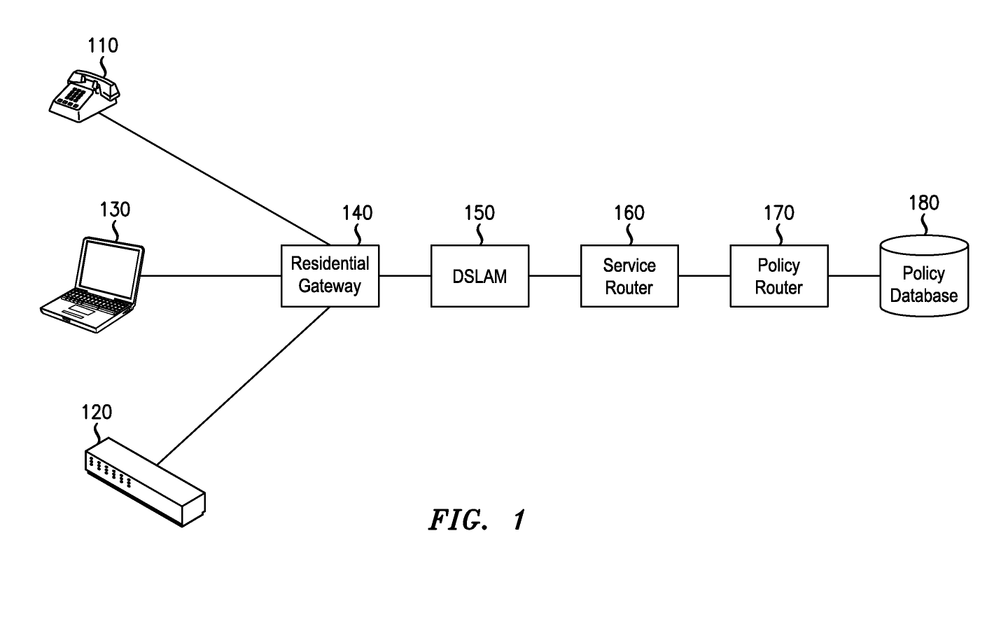

FIG. 1 illustrates an exemplary communications network 100. Communications network 100 may be a communications network for providing service to residential or business subscribers. Accordingly, communications network 100 may be considered a subscriber network. Communications network 100 may include customer equipment such as telephone 110, set top box 120, computer 130, and residential gateway 140. Communications network 100 may also include digital subscriber line access multiplexer (DSLAM) 150, service router 160, policy server 170, and policy database 180.

Telephone 110 may be any telephone capable of providing digital voice over IP (VoIP) communication. Telephone 110 may be a device supplied by a subscriber. Telephone 110 may be a land-line telephone, meaning the telephone call is carried over a wired network rather than a radio-access network. Telephone 110 may establish a voice session with subscriber network 100. As will be discussed in further detail below, telephone 110 may include a vendor class identifier indicating a voice session in an access request when connected to subscriber network 100. As will be discussed in further detail below, a mobile device such as a smart phone, may establish a data session rather than a voice session.

Set top box 120 may be a device that provides video service to a subscriber's television. Set top box 120 may be provided by a service provider as part of a subscriber's service package. In various embodiments, set top box 120 may also include various devices provided by a subscriber. For example, set top box 120 may be a cable card integrated into a television. As another example, set top box 120 may be a third party set top box purchased by the subscriber. As will be discussed in further detail below, set top box 120 may include a vendor class identifier indicating a video session in an access request when connected to subscriber network 100.

Computer 130 may be any device that establishes a data session with network 100. Computer 130 may include desktop computers, laptop computers, tablets, smart phones, and any other device that establishes a data session. Computer 130 may include a vendor class identifier indicating a data session in an access request when connected to subscriber network 100.

Residential gateway 140 may be a device that connects one or more subscriber devices to network 100. In various embodiments, residential gateway 140 may be a wireless router providing a data connection using a wireless protocol such as any of the 802.11 wireless protocols. Residential gateway 140 may also provide for wired Ethernet connections.

DSLAM 150 may be a device controlled by a service provider. The DSLAM 150 may include a plurality of ports for connecting to or residential gateway 140, subscriber premises equipment, or customer located equipment (CLE). Accordingly DSLAM 150 may aggregate the connections of a plurality of subscribers. DLAM 150 may send and receive traffic from a backbone connection to service router 160. In various embodiments, DSLAM 150 may be connected to a fiber optic backbone and function as an optical line terminator (OLT). DSLAM 150 may add physical connection information such as a circuit ID to a service request.

Service router 160 may be a router configured to process data traffic for a subscriber. Service router 160 may receive packets and forward them toward their destinations. Service router 160 may also be involved in subscriber access and authentication. Service router 160 may receive an access request originating from any device connected to CLE device and generate a RADIUS access request to policy server 170. Service router 160 may include any known subscriber and device information in the service request.

Policy server 170 may be a server controlled by a service provider for managing a subscriber network. Policy server 170 may be a RADIUS server communicating with one or more RADIUS clients such as, for example, service router 160. Policy server 170 may be responsible for managing subscriber account information and making policy decisions regarding subscriber sessions. As will be described in further detail below, policy server 170 may be configured with session type limits for individual subscribers. Accordingly, policy server 170 may enforce limits on the number of sessions of a particular type that a subscriber is allowed to establish. Policy server 170 may also be responsible for enforcing service level agreements and processing billing information for subscribers.

Policy database 180 may be a machine-readable storage medium configured to store subscriber information. Policy database 180 may be a stand-alone server or may be incorporated into another network node such as policy server 170. Policy database 180 may store subscriber information including information regarding each current subscriber session and configured subscriber session limits.

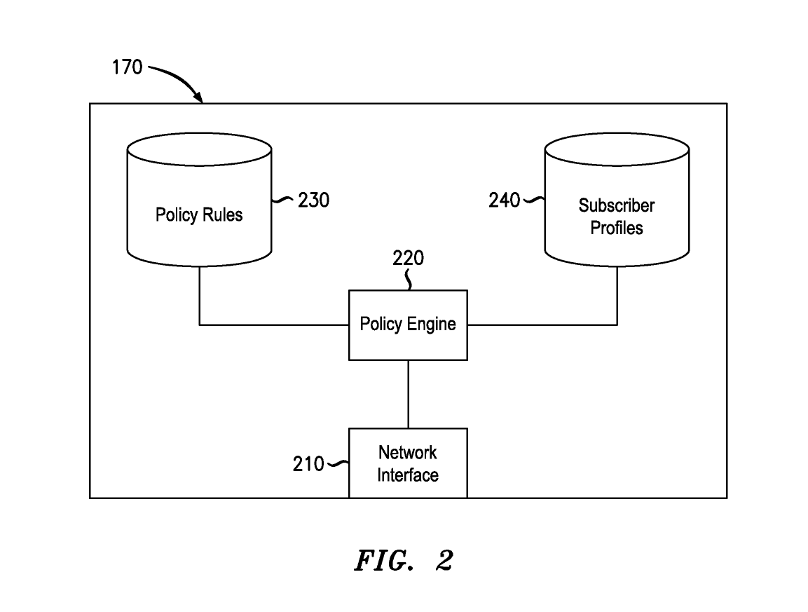

FIG. 2 schematically illustrates an exemplary policy server 170. Policy server 170 may be a computer server including hardware components such as one or more processors, computer-readable memory, and network interface cards. Policy server 170 may include a network interface 210, policy engine 220, policy rules storage 230, and subscriber profiles storage 240. Policy server 170 may include policy database 180 in the form of policy rules storage 230 or subscriber profiles storage 240. Alternatively, policy rules storage 230 or subscriber profiles storage 240 may be an external database accessible to policy engine 220.

Network interface 210 may include hardware and/or instructions encoded on a machine-readable storage medium executed by a processor to send and receive data. In various embodiments, network interface 210 may be configured to communicate using the RADIUS protocol. Network interface 210 may be configured to receive RADIUS messages and extract information in the form of attribute-value-pairs. Network interface 210 may also be configured to generate and transmit RADIUS messages to various RADIUS clients such as a service router 160.

Policy engine 220 may include hardware and/or instructions encoded on a machine-readable storage medium executed by a processor to make policy decisions. Policy engine 220 may evaluate policy rules stored in policy rules storage 230 to make policy decisions. Policy engine 220 may apply the policy rules to information received via network interface 210 as well as information in subscriber profiles storage 240 and any other available information.

Policy rules storage 230 may be a machine-readable storage medium configured to store policy rules for evaluation by a policy engine 220. In particular, policy rules may define logical rules for monitoring and limiting subscriber session types. Policy rules may define how policy engine 220 should classify subscriber sessions by service type. Policy rules may also define how policy engine 220 should apply session limits included in subscriber profiles storage 240 to the subscriber sessions.

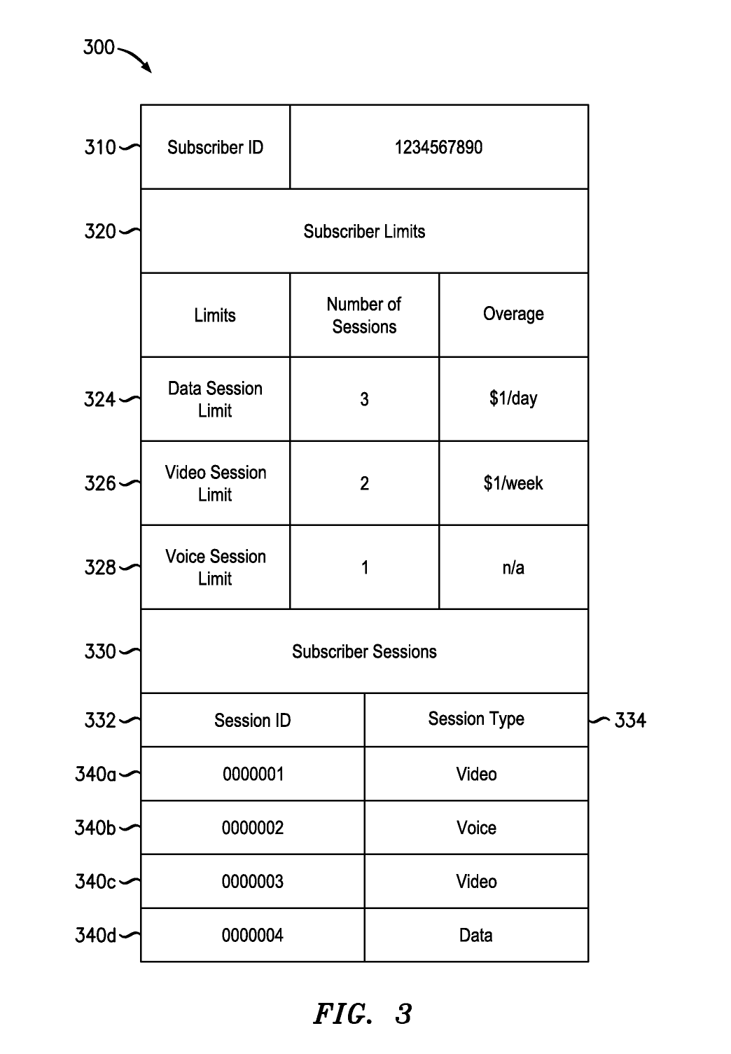

Subscriber profiles storage 240 may be a machine-readable storage medium configured to store subscriber information. As will be described in further detail below regarding FIG. 3, subscriber profiles may include information describing a subscriber's service agreement including any service type limits.

FIG. 3 illustrates an exemplary data arrangement 300 for storing subscriber profile information. Data arrangement 300 may be stored in, for example, policy database 180 or subscriber profiles storage 240. Data arrangement 300 may be stored as, for example, a database table, array, linked list, tree, or any other data structure suitable for storing subscriber profiles. Data arrangement 300 may include subscriber identifier 310, subscriber limits 320, and subscriber session information 330.

Subscriber identifier 310 may include an identifier for the subscriber. The subscriber identifier may include a username, account number, or other unique identifier for the subscriber. Subscriber identifier 310 may also include other subscriber information such as, for example, a subscriber password, and circuit ID.

Subscriber limits 320 may include information describing limits on the subscriber's access. The subscriber limits 320 may be based on a subscriber's service package including any selected options. The subscriber limits 320 may include a data session limit 324, a video session limit 326, and a voice session limit 328. As an example, subscriber profile 300 may indicate a data session limit 324 of 3, indicating that the subscriber may have up to 3 data sessions. Data session limit 324 may further indicate an available overage price for additional data sessions. For example, the subscriber may be able to obtain additional data sessions by agreeing to pay an overage charge per session per day. Video session limit 326 may indicate that the subscriber may have up to two video sessions. Video session limit 326 may be based on a number of televisions indicated when the subscriber selected a service package. Voice session limit 328 may indicate a maximum number of voice sessions a subscriber may have. For example, voice session limit 328 may indicate that the subscriber is allowed one voice session. The voice session limit 328 may be based on the number of telephone numbers requested by the subscriber.

Subscriber sessions 330 may include information for each active subscriber session. Subscriber sessions 330 may include a session ID field 332 and a session type field 334. Subscriber sessions 330 may include fields for any other information that may be useful to store for a session. Subscriber sessions 330 may include a plurality of entries 340 including information for active sessions. For example, entry 340a may indicate a video session, entry 340b may indicate a voice session, entry 340c may indicate a video session, and entry 340d may indicate a data session. A new entry 340 may be created whenever a new session is accepted by policy server 170. An entry 340 may be deleted whenever a session is terminated.

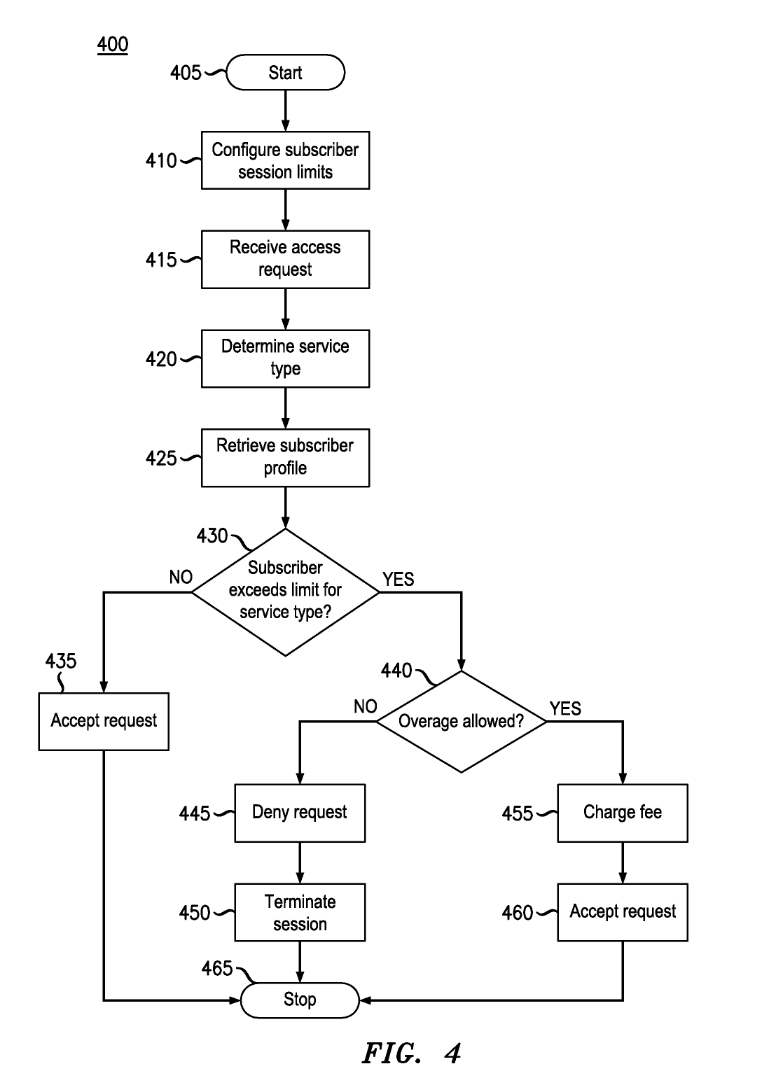

FIG. 4 illustrates a flowchart showing an exemplary method 400 of making policy decisions. Method 400 may be performed by policy server 170. The method 400 may begin at step 405 and proceed to step 410.

In step 410, a network operator may configure subscriber session limits 320. The subscriber session limits 320 may be stored in policy database 180 and/or subscriber profiles storage 240. The subscriber session limits 320 may be configured based on a service agreement between the subscriber and the network operator. The subscriber session limits 320 may include session type limits. The subscriber session limits may also be configured to indicate whether the limit allows overage and the charging rate for any overage.

In step 415, the policy server 170 may receive an access request message originating from a subscriber device. The subscriber device may initially request access using DHCP protocol. A subsequent network node, such as service router 160, may include information from a DHCP request in a RADIUS Access-Request received by policy server 170. The access request message may request a new session to provide service to the subscriber device.

In step 420, the policy server 170 may determine the service type of the access request. The policy server 170 may extract a vendor class ID from the access request. The vendor class ID may be a DHCP vendor class ID, or DHCP option 60. The vendor class ID may include various information regarding the subscriber device including a text string. The policy server 170 may parse the vendor class ID to extract the text string. The policy server 170 may then analyze the text string to determine a session type.

In various embodiments, the policy server 170 may use policy engine 220 to evaluate policy rules 230 based on the text string. The policy rules 230 may include mappings of known text strings to the type of device. The mappings may include generic strings that may be included. For example, if the text string includes the string “HSI” the policy server 170 may determine that the requested session is a data session. If the text string includes the string “VoIP”, the policy server 170 may determine that the requested session is a voice session. If the text string includes the string “STB”, the policy server 170 may determine that the requested session is a video session. The policy rules 230 may also include specific text strings used as vendor class identifiers by specific products. For example, the policy rules storage 230 may include a rule for a device using high speed internet that does not include the HSI string. The rule may include the string, or part thereof, used by the particular device. Policy rules storage 230 may be updated as new devices using different vendor class identifiers become known. A default rule may determine a session type for cases where the vendor class identifier is unknown. The default rule may also log the unknown vendor class identifiers for operator identification and update of the policy rules storage 230.

In step 425, the policy server 170 may retrieve a subscriber profile for the subscriber. The policy server 170 may extract a username or other identifier included in the access request to determine the subscriber. The policy server may query subscriber profile storage 240 for a subscriber profile matching the subscriber identifier.

In step 430, the policy server 170 may determine whether the requested session would exceed a limit for the service type. The policy server 170 may determine a session type limit associated with the service type of the access request. For example, if the access request includes a request for a video session, the policy server 170 may retrieve the video session limit 326 from the subscriber profile 300. The policy server 170 may also determine the current number of sessions matching the session type by checking the session type field 334 for each entry 340. If the current number of sessions matching the session type is less than the session type limit, the method 400 may proceed to step 435. If the current number of sessions matching the session type is greater than or equal to the session type limit, the method 400 may proceed to step 440.

In step 435, the policy server 170 may accept the access request. The policy server 170 may update subscriber profile 300 with the new session by adding a new entry 340. The policy server 170 may also send an Access-Accept message to service router 160. In various embodiments, policy server 170 may also act as an accounting server. Accordingly, policy server 170 may begin monitoring usage of the new session. The method 400 may then proceed to step 465, where the method ends.

In step 440, the policy server 170 may determine whether overage is allowed for the session type limit. The policy server 170 may check an overage field of subscriber limits 320 to determine whether overage is allowed for the subscriber. The policy server 170 may also use policy rules to determine whether overage is allowed. If overage is not allowed, the method 400 may proceed to step 445. If overage is allowed, the method 400 may proceed to step 455.

In step 445, the policy server 170 may deny the access request. Policy server 170 may send an Access-Reject message. In step 450, the policy server 170 may send a message to service router 160 for terminating the associated session from the subscriber equipment. The method 400 may then proceed to step 465, where the method ends.

In step 455, the policy server 170 may charge the overage fee to the subscriber. In various embodiments, policy server 170 may also be an accounting server. Accordingly, policy server 170 may update the subscriber information with the new charge. Alternatively, policy server 170 may send a message to an accounting or billing server indicating the overage charge. In step 460, the policy server 170 may accept the access request. Accordingly, step 460 may be similar to step 435. Policy server 170 may add an entry 340 to subscriber profile 300 indicating the new session. The entry 340 may also indicate that the new session is an overage session. When policy server 170 deletes any entry 340, policy server 170 may determine whether any overage session should be converted to a regular session. The method may then proceed to step 465, where the method ends.

Having described the various components of network 100 and a method of making policy decisions, an example of the operation of network 100 will now be provided. A subscriber may have an account with the service provider to provide various network services such as voice, video, and data. The service provider may maintain a subscriber profile 300 for the subscriber including limitations on the account. The subscriber may have several devices already connected to the network. For example, subscriber profile 300 illustrates four sessions including two video sessions, one voice session, and one data session. The subscriber may then attempt to connect another device to the network. For example, the subscriber may attempt to connect another set top box 120. Upon connection, the set top box 120 will generate a DHCP message requesting access. The DHCP message may include option 60 including the string “STB” indicating the type of subscriber device. DSLAM 150 and service router 160 may add additional information to the request and reformat the request as a RADIUS access request.

Policy server 170 may receive the access request and extract the option 60 information. Based on the presence of the “STB” string, policy server 170 may determine that the request is for a new video session. Policy server 170 may then determine whether the subscriber profile allows the additional session. According to subscriber profile 300, the subscriber has a video session limit 326 of two. Subscriber profile 300 also indicates two existing video sessions in entries 340a and 340c. Therefore, policy server 170 may determine that the session type limit has been exceeded. Policy server 170 may then determine that overage is allowed based on the overage field of the video session limit 326. Policy server 170 may then automatically charge the subscriber for the overage. Policy server 170 may then store the new session in subscriber profile 300 and send an Access-Accept message to the service router 160, which will provide service to the set top box 120.

Alternatively, if the subscriber had connected a new computer 130, policy server 170 may determine that an additional data session is allowed and add the new data session without charging an overage fee. On the other hand, if the subscriber had connected a new phone 110, policy server 170 may determine that an additional voice session is not allowed and deny the access request.

According to the foregoing, various exemplary embodiments provide for network operator control of subscriber sessions. In particular, by establishing session type limits, a network operator may control the types of devices connected to a network.

It should be apparent from the foregoing description that various exemplary embodiments of the invention may be implemented in hardware and/or software executed by a processor. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a policy server in a communication network comprising:
receiving an access request message including a vendor class identifier describing a device requesting network access;
determining a service type based on the vendor class identifier;
determining whether adding an additional session exceeds a limit for the service type; and
performing a management action responsive to the additional session exceeding the limit for the service type.

2. The method of claim 1, wherein the management action comprises rejecting the additional session.

3. The method of claim 2, wherein the management action further comprises sending a termination request to a service router.

4. The method of claim 1, wherein the management action comprises charging an overage fee for the additional session.

5. The method of claim 1, wherein the vendor class identifier is a dynamic host configuration protocol (DHCP) option 60.

6. The method of claim 5, wherein the step of determining a service type based on the vendor class identifier comprises comparing the vendor class identifier to predefined identifiers.

7. The method of claim 6, further comprising adding an additional vendor class identifier to the predefined identifiers.

8. The method of claim 1, wherein the service type is one of: a data session, a voice session, and a video session.

9. The method of claim 1, wherein the step of determining whether adding an additional session exceeds a limit for the service type comprises:
determining a current session count for the service type;
determining a session limit for the service type; and
determining whether the current session count is greater than or equal to the session limit.

10. The method of claim 1, further comprising configuring a subscriber profile with a session limit for a service type.

11. A policy server in a communication network comprising a processor, the policy server configured to:
receive an access request message including a vendor class identifier describing a device requesting network access;
determine a service type based on the vendor class identifier;
determine whether adding an additional session exceeds a subscriber limit for the service type; and
perform a management action responsive to the additional session exceeding the limit for the service type.

12. The policy server of claim 11, wherein the management action comprises rejecting the additional session.

13. The policy server of claim 12, wherein the management action further comprises sending a termination request to a service router.

14. The policy server of claim 11, wherein the management action comprises charging an overage fee for the additional session.

15. The policy server of claim 11, wherein the vendor class identifier is a dynamic host configuration protocol (DHCP) option 60.

16. The policy server of claim 15, wherein the policy server is configured to compare the vendor class identifier to predefined identifiers.

17. The policy server of claim 16, wherein the policy server is further configured to add an additional vendor class identifier to the predefined identifiers.

18. The policy server of claim 11, wherein the service type is one of a data session, a voice session, and a video session.

19. The policy server of claim 11 wherein the policy server is further configured to:
determine a current session count for the service type;
determine a session limit for the service type; and
determine whether the current session count is greater than or equal to the session limit.

20. The policy server of claim 11, wherein the policy server further comprises a machine-readable storage medium configured to store a subscriber profile including a session limit for a service type.
